(19) United States
(12) Patent Application Publication
(10) Pub. No.: US 2011/0180531 A1
(43) Pub. Date: Jul. 28, 2011

(54) Induction heater having flexible geometry

(75) Inventor: Sunil Shinha, Houston, TX (US)

(73) Assignee: AIR GENERATE INC

(21) Appl. No.: 12/657,596

(22) Filed: Jan. 25, 2010

(51) Int. Cl. H05B 6/10

(52) U.S. Cl. 219/630; 29/602.1

(57) ABSTRACT

Heating the liquid at a point substantially close to point of use, by utilizing the heat generated in the electromagnetic induction process. The induction heating apparatus may be made of a flexible and non-conducting material comprising induction coil and the apparatus may be wrapped around the liquid carrying structure (e.g., pipe) at a point, which may be substantially close to a point of usage (liquid delivery point or an outlet point). The liquid passing through the liquid carrying structure may be heated as it passes through the portion of the liquid carrying structure around where the induction heating apparatus is wrapped. In other approach, the induction heating apparatus may be placed inside the shower head and faucet and the parameters such as temperature, flow rate, pressure, and steam generating may be controlled using an electronic control module.

### FIELD OF INVENTION

The present invention in general relates to induction heating and in particular relates to an induction heater having flexible geometry.

### BACKGROUND OF INVENTION

Induction heating apparatus typically comprise an induction coil and an element to be heated. The induction coil is generally made of conducting element, which is wound around the element to be heated without physical contact between induction coil and element to be heated. The induction coil is connected to a power source and an electric current is made to flow through the induction coil. The flow of electric current through the coil in a direction “X” causes an intense and rapidly changing magnetic flux to be generated in a direction “Y”, which is substantially perpendicular to the direction of electric current (“X”). The magnetic flux causes eddy current in the element to be heated, that in turn generates heat in the element to be heated almost instantaneously.

In the induction heating apparatus, the induction coil is firmly and rigidly arranged around the element to be heated. Such rigid arrangement makes the present induction heating apparatus bulky in size and less portable. It may be difficult, inconvenient, time consuming and cost prohibitive, if the induction heating apparatus has to be replaced, for example, in case of malfunctioning of such induction heating apparatus. An yet another disadvantage of the present induction heating apparatus is that a separate pipe is to be provisioned for carrying the hot liquid from the point of heating to the point of usage. Another disadvantage of using the present induction heating apparatus is that the user may lose time in draining out the cold liquid stored in the pipe between the point of heating and the point of usage before collecting the hot liquid and also, some amount of cold liquid, which may be drained out may be lost.

### BRIEF DESCRIPTION OF DRAWINGS

The invention herein described is by the way of example and not by the way of limiting by supplementing to the figures drawn. For clarity and simplicity of illusion, the elements in the figure are not necessarily drawn to the scale. For instance, dimension of some of the elements magnified when compared to other elements for clarity.

FIG. 1 illustrates an arrangement 100, in which induction heating apparatus is used for heating liquid.

FIG. 2 illustrates an arrangement 200, in which the construction details of an induction heater having flexible geometry in accordance with an embodiment.

FIG. 3 is a flow chart illustrating an operation of the induction heater having flexible geometry in accordance with an embodiment.

FIG. 4 illustrates a liquid heating system, which may use the induction heater having flexible geometry in accordance with an embodiment.

FIG. 5 illustrates a shower head 500, which includes the induction heater having flexible geometry in accordance with an embodiment.

FIG. 6 illustrates a faucet 600, which includes the induction heater having flexible geometry in accordance with an embodiment.

FIG. 7 illustrates a liquid heating system in which the induction heater having flexible geometry may be used in accordance with an embodiment.

FIG. 8 illustrates heating of liquid instantaneously in a liquid carrying structure made of non conducting material, in accordance with an embodiment.

FIG. 9 illustrates heating of liquid or gas instantaneously and uniformly in a liquid carrying structure made of conducting or non conducting material, in accordance with an embodiment.

### DETAILED DESCRIPTION

The following description describes an induction heater having flexible geometry. In the following description, numerous specific details and choices are set forth in order to provide a more thorough understanding of the present invention. It will be appreciated, however, by one skilled in the art that the invention may be practiced without such specific details. In other instances, constructional details and other such details have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that, it is within the knowledge of one skilled in the art to affect such feature, structure, or characteristic in connection with other embodiments whether or not explicitly described.

The induction heating apparatus with flexible geometry may be made of a flexible and non-conducting material with an induction coil included into the flexible and non-conducting material. In one embodiment, the induction coil may be embedded or fixed firmly into the flexible and non-conducting material. The combination of the induction coil included into the flexible and non-conducting material may be formed into any flexible geometry. In one embodiment, the flexible geometry may be in the form of a flexible strap, which may be wrapped around the element to be heated. In other embodiment, the induction heating apparatus may be in the form of a sticker, which may be stuck to the surface that is to be heated.

In one embodiment, the induction heating apparatus with flexible geometry may be compact, flexible, and portable. In one embodiment, the induction heating apparatus with flexible geometry may be easily carried, for example, in a compact carry case. In one embodiment, the induction heating apparatus may be wrapped around a structure (e.g., pipe) provisioned to carry liquid, gas, or any other substance in any other form at a point, which may be substantially close to a point of usage (liquid delivery point or an outlet point). In one embodiment, the induction heating apparatus may be coupled to a power source, which may cause the liquid passing through the liquid carrying structure to be heated, instantaneously, as it passes through the portion of the liquid carrying structure around which the induction heating apparatus is wrapped. In other approach, the induction heating apparatus may be placed inside the shower head or a faucet to heat the liquid passing through the shower head instantaneously. In one embodiment, the induction heating apparatus may be coupled to a control unit to control parameters of the liquid such as temperature, flow rate, pressure, and steam generation.

In one embodiment, the advantages of using the induction heating apparatus having flexible geometry are as follows: (1) save at least some amount of cold liquid that is stored in the pipe between the point of heating and the point of usage that otherwise may be drained out and wasted; (2) save a second pipe installed to provide an alternate route for the hot liquid; (3) used to heat liquid, gases, semi liquid or any other such substance that may be used in both industrial and domestic purposes; (4) provide uniform heating of liquids and gases passing through a pipe that includes inner packing of ferrous material; and (5) use of a separate heating chamber for heating the liquid, gases or other substance in any other form may be avoided.

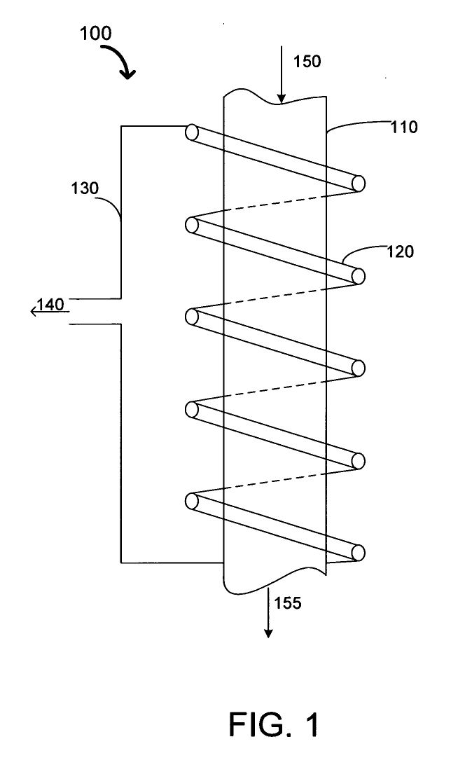

An arrangement 100 of an induction heating apparatus is illustrated in FIG. 1. The arrangement 100 may comprise a conducting structure 110, an induction coil 120 and a power source 140. The induction coil 120 may be arranged such that a flow of electric current in the induction coil 120 may cause maximum magnetic flux to be linked with the conducting structure 110. The magnetic flux may cause eddy currents in the conducting structure 110, which may in turn cause heating effect in the conducting structure 110.

For example, the liquid, which is to be heated, may be passed through the conducting structure 110 from inlet 150. The conducting structure 110 may be made of ferrous metal, alloys of ferrous or any other such conducting material. The induction coil 110 may be coupled to a power source 140, which may include a conventional power source or a non-conventional power source. The induction coil 120 may be connected to the electric supply 140 by electric wire 130 and electric current is passed through the induction coil 120, which generates magnetic flux around the coil. The magnetic flux generates eddy current in the conducting structure 110, which may generate heat in the conducting structure 110. The heat generated in the conducting structure 110 may heat the liquid flowing through the conducting structure 110 by various heat transfer methods such as conduction, convection, radiation and the heating process may be instantaneous. However, the arrangement 100 may be rigid, bulky and not portable because of the elements used and also because of the mode in which they are arranged.

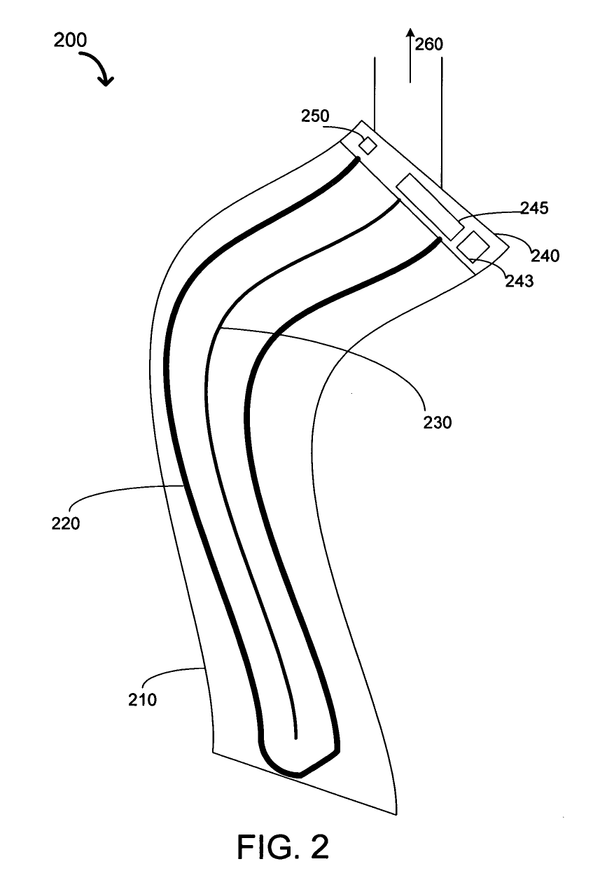

In one embodiment, an induction heating apparatus with flexible geometry may be used to overcome the disadvantages mentioned above. An embodiment of the induction heating apparatus with flexible geometry is illustrated in FIG. 2. In one embodiment, the induction heating apparatus 200 with flexible geometry may comprise a flexible non-conducting material 210, an induction coil 220, a flexible galvanized metallic wire 230 and a control module 240 with display unit 245 and a temperature control user interface 250.

In one embodiment, a flexible material 210 may be used to include the induction coil 220, which together (combination) may form the induction heating apparatus 200 with flexible geometry. In one embodiment, the flexible material 210 may include an insulating material such as flexible rubber, plastic, composite material, high temperature cloth or any such other materials, which may be non electric conductors. In one embodiment, the flexible material 210 may withstand high temperature. In one embodiment, the flexible material 210 may be molded into any geometric shape after embedding (or including) the induction coil 220 into the flexible material 210. In one embodiment, the combination of flexible material 210 and the induction coil 220 may be compact, portable and flexible and for example, may be wrapped around any structure that may be heated. In one embodiment, the induction heating apparatus with flexible geometry may be easily carried around in a compact carry case. In one embodiment, the induction heating apparatus 200 may be formed in any geometric shape such as a rectangular strap, triangular, circular, square, pentagonal, hexagonal, octagonal, decagonal flexible pads. Such an approach may allow the induction heating apparatus 200 to be used along with any structure in any place.

In one embodiment, the induction heating apparatus 200 may further comprise a flexible galvanized metallic rod 230. The galvanized rod 230 may be included into the flexible material 210 to avoid corrosion of a conducting structure around which the induction heating apparatus 200 may be wrapped. In one embodiment, the conducting structure may corrode due to exposure of the conducting structure to high temperatures generated by the eddy currents. In another embodiment, the galvanized metallic rod 230 may be included into flexible material 210 to enhance heating of the conducting structure.

In one embodiment, a control unit 240 may be coupled to the flexible material 210. In one embodiment, the control unit 240 may comprise a microprocessor 243, a display unit 245 and a user interface 250. The microprocessor 243 may be programmed to control the temperature of the induction heating apparatus 200. The required temperature of liquid may be set by using user interface 250.

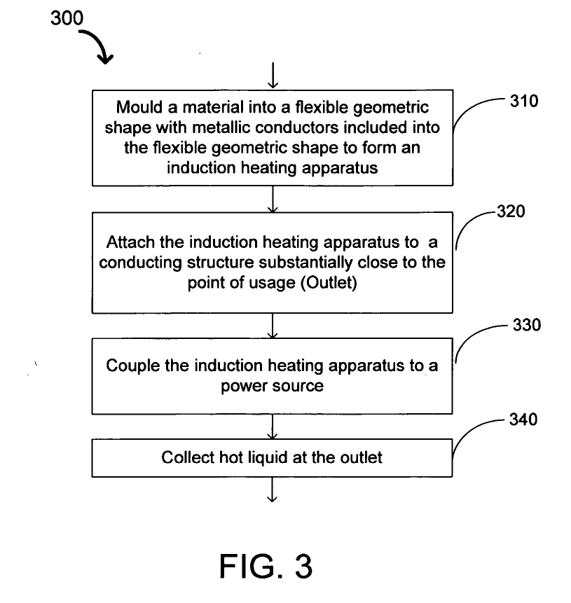

An embodiment of an operation of induction heating apparatus 200 including the flexible geometry is illustrated in a flow chart of FIG. 3. In block 310, the induction heating apparatus 200 with flexible geometry may be formed by molding a material like the flexible material 210 into a flexible geometric shape with metallic conductors like induction coil 220 included into the flexible geometric shape. In one embodiment, the flexible material 210 may be heated until the flexible material 210 changes its state into a semi solid or a liquid state. In one embodiment, the induction coil 220 may be placed in a mould and the flexible material 210 in liquid state may be injected into the mould. In one embodiment, the flexible material 210 in liquid state may be allowed to cool down. In one embodiment, the combination of the flexible material 210 and the induction coil 220 may be referred to as the induction apparatus 200 with flexible geometry as illustrated in FIG. 2.

In other embodiment, the induction coil 220 may be pressed into the flexible material 210, which may be in semi solid state. In one embodiment, the flexible material 210 may be allowed to cool down to room temperature after press fitting the induction coil 220. In one embodiment, the combination of the flexible material 210 with the induction coil 220 press fitted may form the induction heating apparatus 200 with flexible geometry. Any other approach may be used to form the induction apparatus 200 with flexible geometry and such approaches are contemplated to be within the scope of the present invention.

In block 320, attach the induction heating apparatus 200 to a conducting structure substantially close to the point of usage (Outlet). In one embodiment, the induction heating apparatus 200 may be wrapped around the surface of conducting structure substantially close to the point of usage. In one embodiment, the conducting structure may comprise a faucet or a shower head or any other such liquid carrying conducting structures. In one embodiment, the induction heating apparatus 200 may be rolled around the conducting structure like a cloth, for example. In one embodiment, the induction heating apparatus 200 may be provided in the form of stickers that may be stuck (adhere) to the conducting structure.

In one embodiment, the induction heating apparatus 200 may be attached substantially close to the point of usage to preserve the temperature of the liquid before collecting the heated liquid at the point of usage. In one embodiment, the liquid may be heated instantaneously just before delivering the heated liquid through the outlet. In one embodiment, attaching the induction heating apparatus 200 to the conducting structure at a point that is substantially close to the point of usage may minimize the heat loss from the heated liquid. If the induction heating apparatus 200 is attached to the conducting structure away from the point of usage, the heated liquid while flowing from the point of heating to the point of usage may lose heat by conduction, convection, or radiation. Such an arrangement may cause wastage of heat and may lead to sub-optimal usage of resources.

In block 330, couple the induction heating apparatus 200 to the power source 260 for supply of power to induction heating apparatus 200. However, the power source may be conventional power source or may be non-conventional power source, or any such power source, which provides electric supply to induction heating apparatus 200. In one embodiment, the flow of electric current in the induction heating apparatus 200 may generate magnetic flux. The magnetic flux in turn may generate eddy currents in the conducting structure leading to generation of heat in the conducting structure. In one embodiment, the temperature of the liquid may be controlled by providing a preset temperature value using the user interface 250 provisioned in the control module 240.

In block 340, the liquid may be passed through the conducting structure. In one embodiment, the conducting structure may be made of ferrous metal, ferrous alloy or any other metal that may generate heat while being exposed to magnetic flux. In one embodiment, the conducting structure may have shape such as regular shape or irregular shape or any such other shapes. Further, the conducting structure comprises of at least one inlet and at least one outlet. The liquid that may be heated may be passed through inlet of conducting structure. The liquid may be heated at a portion where induction heating apparatus 200 may be attached to the conducting structure and the liquid heated to a preset temperature level may collected at the outlet. Yet in another embodiment, the induction heating apparatus 200 may be attached to the surface of the conducting structure.

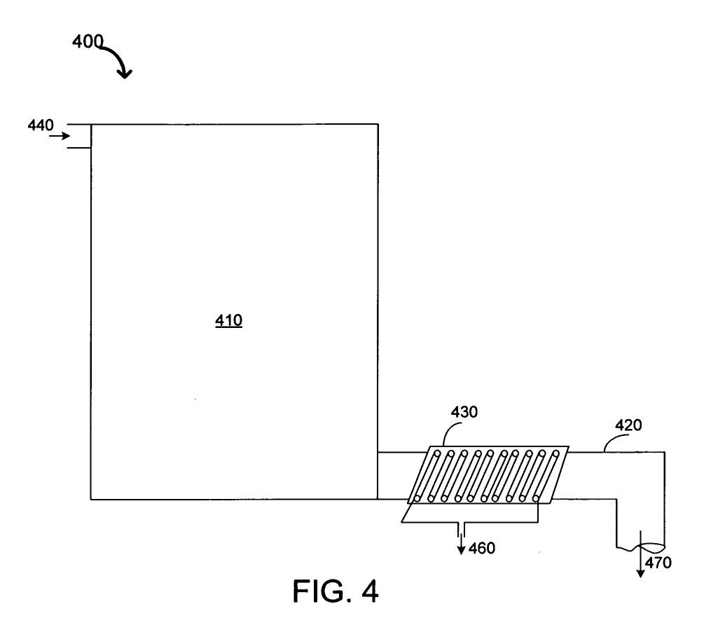

In one embodiment, liquid heating system using induction heating apparatus with flexible geometry is illustrated in FIG. 4. In one embodiment, the arrangement 400 may comprise a liquid tank 410, a liquid carrying structure 420, a liquid outlet 470, and an induction heating apparatus 430. In one embodiment, the induction heating apparatus 430 may be attached to the liquid carrying structure 420. The induction heating apparatus 430 may be similar to the induction heating apparatus 200 described above with reference to FIG. 2. In one embodiment, the induction heating apparatus 430 may be attached to the liquid carrying structure 420 substantially close to the point of usage 470. In one embodiment the liquid carrying structure 420 may have regular or irregular shapes or any other such shape, which allow the liquid to pass through.

In one embodiment, induction heating apparatus 430 may be coupled to the power source 460 to allow an electric current to pass through the induction heating apparatus 430. In one embodiment, the induction heating apparatus 430 may heat the liquid flowing through the liquid carrying structure 420 in response to the passage of electric current through induction heating apparatus 430. In one embodiment, the liquid flowing through the liquid carrying structure 420 may get heated up to the preset temperature and may be collected at the outlet 470 of liquid carrying structure 420.

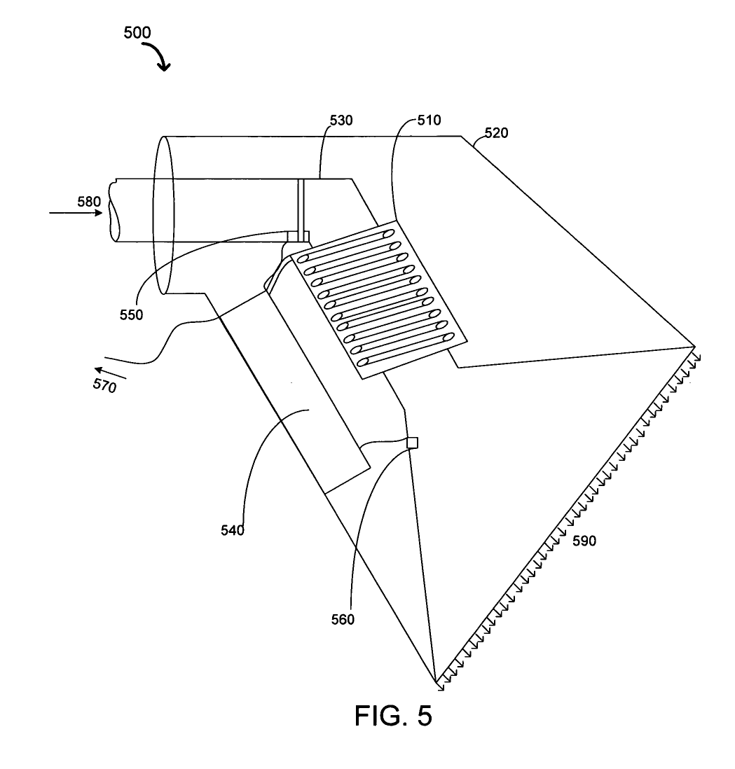

An embodiment of shower head 500, which may be coupled to an induction heating apparatus 510, is illustrated in FIG. 5. In one embodiment, the shower head 500 may comprise an induction heating apparatus 510, a control unit 540, a liquid carrying structure 530, a temperature sensor 560 and a flow control valve with flow sensor 550. The induction heating apparatus 510 may be similar to the induction heating apparatus 200 described above with reference to FIG. 2. In one embodiment, the induction heating apparatus 510 may be attached to a liquid carrying structure 530 substantially close to the outlet 590 of shower head 500. In one embodiment, the portion comprising induction heating apparatus 510 may be covered by an outer cover 520. In one embodiment, the control unit 540 may be provided within the induction heating apparatus 510 or may be provided external to the induction heating apparatus 510. In one embodiment, the control unit 540 is shown external to the induction heating apparatus 510 for clarity. In one embodiment, the control unit 540 may be used to control one or more parameters of the liquid flowing through liquid carrying structure 530. In one embodiment, the one or more parameters include flow rate, steam generation, temperature and other such parameters. In one embodiment, the flow rate of the liquid may be controlled by the control valve provisioned with flow sensor 550. In one embodiment, temperature may be controlled by controlling the supply of voltage, current, frequency of the supply to the induction heating apparatus 510. In one embodiment, the temperature sensor 560 may be provisioned substantially close to the outlet 590 of the shower head 500 and the temperature sensor 560 may sense the temperature of liquid and provide feedback to the control unit 540 to maintain the temperature of the liquid at a preset value.

In one embodiment, induction heating apparatus 510 may be coupled to the power source 570 to allow an electric current to pass through the induction heating apparatus 510. In one embodiment, the induction heating apparatus 510 may heat the liquid flowing through the liquid carrying structure 530 in response to the passage of electric current through induction heating apparatus 510. In one embodiment, the liquid flowing through the liquid carrying structure 530 may get heated up to the preset temperature and may be collected at the outlet 590 of shower head 500.

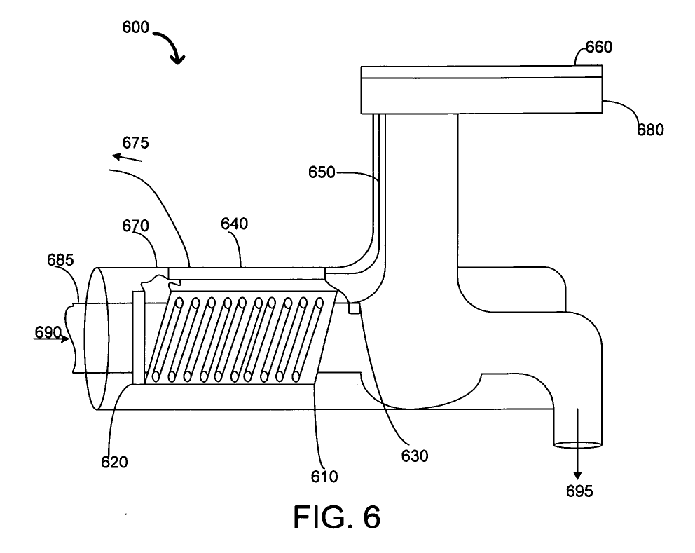

An embodiment of a faucet 600, which may be coupled with induction heating apparatus 610, is illustrated in FIG. 6. In one embodiment, the faucet 600 may comprise an induction heating apparatus 610, a control unit 640, a user interface 660, a control valve with flow sensor 620 and a temperature sensor 630. The induction heating apparatus 610 may be similar to the induction heating apparatus 200 described above with reference to FIG. 2. In one embodiment, faucet 600 may include a liquid carrying structure 685. In one embodiment, the induction heating apparatus 610 may be attached to the liquid carrying structure 685 substantially close to the point of usage. In one embodiment, the portion where the induction heating apparatus 610 is attached to the liquid carrying structure 685 may be covered with the external cover 670. In one embodiment, the user interface 660 to control the parameters such as flow rate, temperature, and such other parameters may be provided at the top of the handle 680. Further, the faucet 600 may also include a child lock to avoid inadvertent use of the faucet 600.

In one embodiment, induction heating apparatus 610 may be coupled to the power source 675 to allow an electric current to pass through the induction heating apparatus 610. In one embodiment, the induction heating apparatus 610 may heat the liquid flowing through the liquid carrying structure 685 in response to the passage of electric current through induction heating apparatus 610. In one embodiment, the liquid flowing through the liquid carrying structure 685 may get heated up to the preset temperature and may be collected at the outlet 695 of faucet 600.

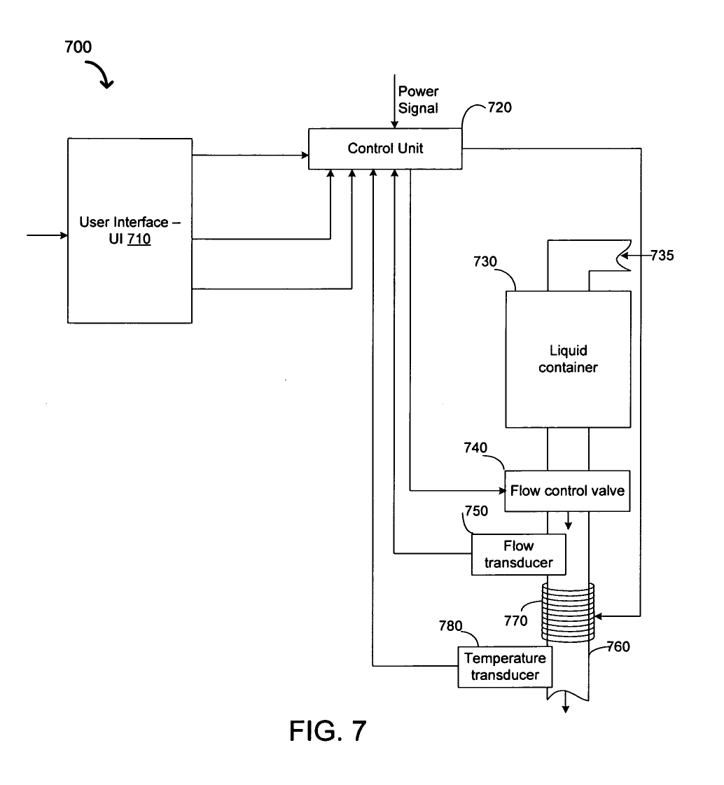

An embodiment of a liquid heating system 700 comprising an induction heating apparatus 770 is illustrated in FIG. 7. In one embodiment, the liquid heating system 700 may comprise a user interface UI 710, control unit 720, a liquid container 730, a liquid carrying structure 760, a flow control valve 740, a flow transducer 750, a temperature transducer 780 and an induction heating apparatus 770. In one embodiment, the liquid container 730 further comprises an inlet 735 and an outlet at the liquid carrying structure 760. In one embodiment, the induction heating apparatus 770 may be attached to the liquid carrying structure 760 at substantially close to the outlet.

In one embodiment, the user interface UI 710 may include an interface for a user to select the frequency, current, voltage, phase, temperature, flow rate and any other such similar parameters. In one embodiment, the user interface UI 710 may convert the inputs provided by the user into electrical signals and such electrical signals may be provided as inputs to the control unit 720. In one embodiment, the user selected values may be used to vary frequency, current, voltage, phase, temperature, flow rate and any other such similar parameters of a power signal provided by the power supply. In one embodiment, the control unit 720 may change the parameters of the power signal based on user selected values. In one embodiment, the control unit 720 may comprise conversion circuits such as voltage to frequency, voltage to current, current to frequency and other such similar circuits. For example, the user may select high frequency mode of operation and the user selected value may be used to change the frequency of the power signal to a higher value. In other embodiment, the preset temperature value provided by the user using UI 710 may be received at the control unit 720 as a voltage signal and the control unit 720 may change one or more parameters of the power signal to control the temperature of the liquid at the outlet. In yet another embodiment, the control unit 720 may receive a feedback temperature value from the temperature transducer 780 and may change the one or more parameters of the power signal based on the difference between the preset temperature value and the feedback temperature value. In one embodiment, the modified parameters of the power signal form the control unit 720 may provide to the induction heating apparatus 770.

In one embodiment, control unit 720 may control the operation of flow control valve 740 based on the preset flow rate value provided by the user. In one embodiment, the flow transducer 750 may sense the flow rate of liquid flowing inside the liquid carrying structure 760. In one embodiment, flow transducer 750 may convert the liquid flow rate into electrical signal and provide a feedback flow rate value to the control unit 720. In one embodiment, the control unit 720 may control the flow rate based on the difference generated by comparing the feedback flow rate value.

In one embodiment, the control unit 720 may generate a power signal with the parameters modified based on the user provided inputs and the feedback values. In one embodiment, the power signal with modified parameters may be provided to the induction heating apparatus 770, which may be attached to a liquid carrying structure 776 at a point that is substantially close to the point of usage (or outlet). In one embodiment, induction heating apparatus 770 may generate magnetic flux based on the power signal with modified parameters and the magnetic flux so generated may be used to maintain temperature of the liquid at the outlet.

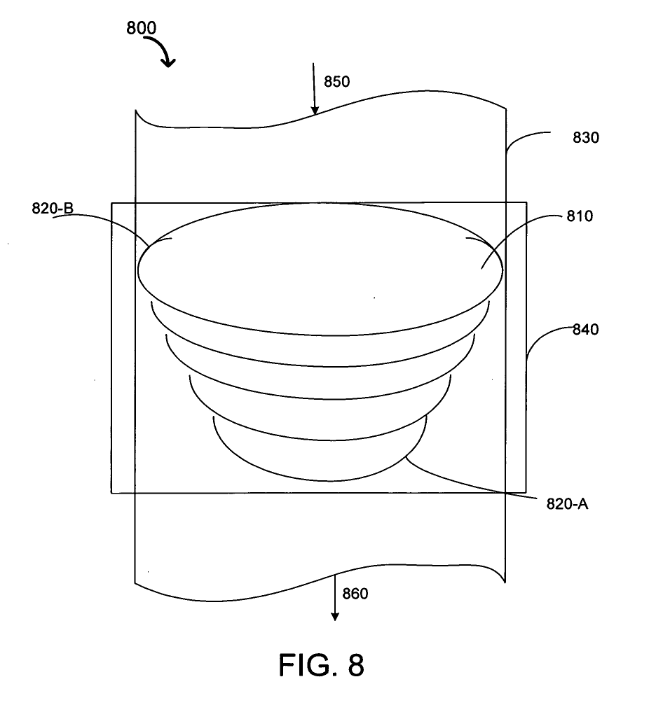

An embodiment of a liquid carrying structure made of non conducting material, which may be used to instantaneously heat the liquid using the liquid heating apparatus described above is illustrated in FIG. 8. In one embodiment the liquid carrying structure 830 may be made of a non conducting material such as plastic, wood, ceramic and such other similar materials. In one embodiment, a coil 810 made of a conducting material may be placed inside the liquid carrying structure 830. In one embodiment, the coil 810 may include a conductor wound in the form of a coil of uniform diameter or of variable diameter. In one embodiment the shape of conducting material may be of any shape such as coil, spring, zigzag or any other such shape, which may fit into the liquid carrying structure 830. In one embodiment, the conducting material may be galvanized and made corrosion free. In one embodiment, the induction heating apparatus 840, which may be similar to the induction heating apparatus 200 may be attached to the liquid carrying structure 830. In one embodiment, the induction heating apparatus 840 may produce magnetic flux in response to receiving power signal and the magnetic flux lines may cause heat to be generated in the coil 810 placed inside of the liquid carrying structure 830. As a result, the liquid flowing through the liquid carrying structure 830 may be heated as the heat gets transferred from the heated coil 810 to the liquid.

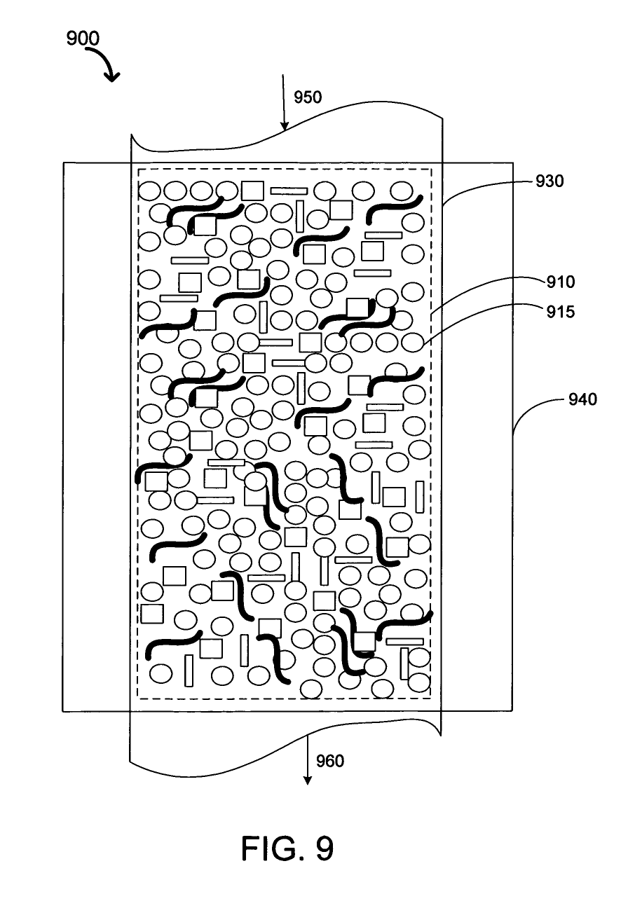

An embodiment of a liquid heating system 900, which may be used to instantaneously and uniformly heat the liquid, gas or any such other such substance flowing through a liquid carrying structure 930, is illustrated in FIG. 9. In one embodiment, the liquid heating system 900 may comprise a porous tube 910 filled with ferrous or magnetic substance 915 and an induction heating apparatus 940.

In one embodiment, the liquid carrying structure 930 may be made of ferrous, ferrous alloys, copper, alloyed metals or any such other conducting material. In other embodiment, the liquid carrying structure 930 may be made of plastic, wood, ceramic and other such similar non conducting materials. In one embodiment, the porous tube 910 may be made of a conducting material or non conducting material and may be placed inside the liquid carrying structure 930. In one embodiment, the porous tube 910 may be filled with the ferrous or magnetic material 915, which may be in the form of pallets, small balls, cut wires or any such other regular or irregular shapes. In one embodiment, the ferrous or magnetic material 915 may be galvanized and made corrosion free. In one embodiment, the induction heating apparatus 940 may be similar to the induction heating apparatus 200. In one embodiment, the induction heating apparatus 940 may be attached to the liquid carrying structure 930. In one embodiment, the induction heating apparatus 940 may produce magnetic flux in response to receiving power signal and the magnetic flux lines may cause heat to be generated in the porous tube 910 or ferrous or magnetic material 915 placed inside of the liquid carrying structure 930. In one embodiment, maximum heat may be uniformly and instantaneously transferred to the liquid, gas or any other substance, which may pass through the liquid carrying structure 930 as the liquid or gas may come in maximum contact with the ferrous or magnetic material 915. In one embodiment, the ferrous or magnetic material 915 filled in the porous tube 910 may have greater surface contact with the liquid, gas or any such other substance flowing through liquid carrying structure 930 to transfer maximum heat uniformly to the liquid or gas.

While the invention has been described with reference to a preferred embodiment, it will be understood by one of ordinary skill in the art that various changes may be made and equivalents may be substituted for elements thereof without departing from the scope of the present invention. In addition many modifications may be made to adopt a particular situation or material to the teachings of the present invention without departing from the essential scope thereof. Therefore, it is intended that the invention not be limited to the particular embodiments disclosed as the best mode contemplated for carrying out this invention, but that the invention will include all of the embodiments falling within the scope of the appended claims.

Various features and advantages of the present invention are set forth in the following claims.

What is claimed is:

1. An induction heating apparatus comprising:
an induction coil, and
a flexible material,
wherein the flexible material is molded to include the induction coil, wherein a combination of the flexible material and the induction coil has flexible geometry,
wherein the induction heating apparatus with the flexible geometry is attachable to a surface of a structure,
wherein the structure includes regular and irregular shapes, wherein the structure is to allow flow of liquid.

2. The induction heating apparatus of claim 1, wherein the combination of the flexible material and the induction coil is wrapped around the structure having an inlet and an outlet.

3. The induction heating apparatus of claim 2, wherein the combination of the flexible material and the induction coil is wrapped around the structure in an area that is substantially close to the outlet.

4. The induction heating apparatus of claim 1, wherein the combination of the flexible material and the induction coil is stuck to the surface of the structure.

5. The induction heating apparatus of claim 4, wherein the combination of the flexible material and the induction coil is stuck in an area that is substantially close to the outlet.

6. The induction heating apparatus of claim 1, wherein the combination of the flexible material and the induction coil is to generate magnetic flux causing eddy currents in the structure in response to a flow of electric current through the induction coil.

7. The induction heating apparatus of claim 1 further comprises a galvanized metallic rod included into the flexible material, wherein the galvanized rod is to enhance the heat transferred to the liquid flowing through the structure.

8. The induction heating apparatus of claim 1, wherein the induction coil is made of a conducting material.

9. The induction heating apparatus of claim 1, wherein the flexible material is made of non conducting material.

10. The induction heating apparatus of claim 1, wherein the flexible material is made of a high temperature fiber cloth.

11. The induction heating apparatus of claim 1, wherein the induction coil is press fitted into the flexible material.

12. A heating system comprising:
a container having an inlet and an outlet to store a substance, which is be heated,
a structure coupled to the outlet, and
an induction heating apparatus having flexible geometry,
wherein the induction heating apparatus having flexible geometry is attached to a surface of the structure,
wherein the induction heating apparatus is to include a flexible material, which is molded to include an induction coil, wherein a combination of the flexible material and the induction coil has flexible geometry,
wherein the structure includes regular and irregular shapes,
wherein the structure is to allow flow of substance to be heated.

13. The heating system of claim 12, wherein the induction heating apparatus is wrapped around the structure having an inlet and an outlet.

14. The heating system of claim 13, wherein the induction heating apparatus is wrapped around the structure in an area that is substantially close to a delivery point of the structure.

15. The heating system of claim 12, wherein the induction heating apparatus is stuck to the surface of the structure.

16. The heating system of claim 15, wherein the induction heating apparatus is stuck in an area that is substantially close to the outlet.

17. The heating system of claim 12, wherein the induction heating apparatus is to generate magnetic flux causing eddy currents in the structure in response to a flow of a power signal through the induction coil.

18. The heating system of claim 12 further comprises a galvanized metallic rod included into the flexible material, wherein the galvanized rod is to enhance the heat transferred to the liquid flowing through the structure.

19. The heating system of claim 12, wherein the induction coil is made of a conducting material.

20. The heating system of claim 12, wherein the flexible material is made of non conducting material.

21. The heating system of claim 12, wherein the flexible material is made of a high temperature fiber cloth.

22. The heating system of claim 12, wherein the induction coil is press fitted into the flexible material.

23. The heating system of claim 12 further comprises a variable diameter coil placed inside the structure substantially close to the point of usage, wherein the variable diameter coil is galvanized and the structure is made of non conducting material.

24. The heating system of claim 12 further comprises a porous tube placed inside the structure substantially close to the point of usage, wherein the porous tube is filled with pallets of galvanized ferrous material, wherein the pallets of galvanized ferrous material is to transfer maximum heat to the substance.

25. The heating system of claim 12 further comprises a control unit to control parameters of the power signal provided to the induction heating apparatus to control temperature of the substance in response to an input provided by a user.

26. The heating system of claim 12, wherein the control unit is to control flow rate of the substance through the structure in response to an input provided by a user.

27. A method of making an induction apparatus comprising:
heating a flexible material to generate semi-liquid flexible material,
provisioning an induction coil in a mould,
injecting the semi-liquid flexible material into the mould, and
allowing the semi-liquid flexible material to cool,
wherein a combination of the flexible material and the induction coil is to form the induction heating apparatus.

28. The method of claim 27, wherein the induction coil is press fitted into the flexible material.

29. The method of claim 27, wherein the combination of the flexible material including the induction coil is folded into any regular shape.

30. The method of claim 27, wherein the combination of the flexible material including the induction coil is folded into any irregular shape.

31. The method of claim 27, wherein the combination of the flexible material including the induction coil is attached around a structure, which may be of any regular or irregular shape.

32. The method of claim 27, wherein the combination of the flexible material including the induction coil is wrapped around or stuck to a structure, which may be of any regular or irregular shape.

33. The method of claim 27, wherein the flexible material is made of a non conducting material.

34. The method of claim 27, wherein the flexible material is made of a high temperature fiber cloth.

35. The method of claim 27, wherein the induction coil is made of a conducting material.
